(19) United States
(12) Patent Application Publication
(10) Pub. No.: US 2002/0091752 A1
(43) Pub. Date: Jul. 11, 2002

(54) Distributed computing

(76) Inventor: Bradley M. Firlie, Baltimore, MD (US)

Correspondence Address: FOLEY, HOAG & ELIOT, LLP, PATENT GROUP, ONE POST OFFICE SQUARE, BOSTON, MA, 02109, US

(21) Appl. No.: 10/043,370

(22) Filed: Jan. 9, 2002

Related U.S. Application Data
(60) Provisional application No. 60/260,538, filed on Jan. 9, 2001.

(51) Int. Cl. G06F 15/16; G06F 15/177

(52) U.S. Cl. 709/201; 709/221

(57) ABSTRACT

Distributed processing methods and systems can coordinate and administer the execution of large-scale processor intensive computer models and data analysis used in problem solving. A server initiates a task to an administration module that can decompose the task into parts, or subtasks. The server can assign the subtasks to remote computers, or helpers, and collect the results of those subtasks from the helpers. The helpers can obtain the necessary processing code from the administration module in the form of dynamically linked libraries (dll's). Data to be processed can be obtained from local or remote data sources.

### RELATED APPLICATIONS

This application claims priority to, and incorporates by reference, the entire disclosure of U.S. Provisional Patent Application No. 60/260,538, filed on Jan. 9, 2001.

### FIELD

The methods and systems relate to distributed computing and more particularly to coordinating and administering the processing of tasks on a number of remote processors.

### BACKGROUND

Distributed computing is gaining popularity as a technique for harnessing idle computing power available through large networks such as the Internet. One such example is the Search for Extraterrestrial Intelligence (“SETI”), a project in which millions of computers connected to the Internet process astronomical data in an effort to identify signs of extraterrestrial life. However, existing approaches are typically limited to a specific problem for which client-side software may be downloaded to a number of participating computers, or to a particular type of problem for which processing tasks for clients are known in advance, so that participating computers may be pre-programmed to respond to specific processing requests.

### SUMMARY

A method for distributed computing embodiment comprises sending from a server to a task processing module, a request to process a task; receiving the task at the task processing module; decomposing the task into a plurality of subtasks; returning the subtasks to the server; distributing the subtasks to processors; receiving the subtasks at the processors; determining at the processors if code exists at the processors to process the subtasks received; obtaining at the processors the code from a code source when the code does not exist at the processors; determining at the processors if data exists at the processors for the subtasks received; obtaining at the processors the data from a data source when the data does not exist at the processors; executing at the processors the code to obtain results for the subtasks; notifying the server that the results for the subtasks are obtained; and combining the results of the subtasks to obtain a task result.

A distributed computing system embodiment comprises a server module adapted to request processing of a task; a processing module adapted to receive the task, decompose the task into a plurality of subtasks and return the subtasks to the server; and helper modules adapted to receive the subtasks distributed by the server, to obtain processing code and data to process the subtasks and return subtask results to the server, wherein the subtask results are combined to obtain a task result.

In one embodiment, a method for distributed computing comprises decomposing a task into a plurality of subtasks; distributing the subtasks to processors; determining at the processors if code exists at the processors to process the subtasks received; obtaining at the processors the code from a code source when the code does not exist at the processors; executing at the processors the code to obtain results for the subtasks; and combining the results of the subtasks to obtain a task result. Another embodiment comprises decomposing a task into a plurality of subtasks; distributing the subtasks to processors; determining at the processors if data exists at the processors for the subtasks received; obtaining at the processors the data from a data source when the data does not exist at the processors; executing at the processors the subtasks using the data to obtain results for the subtasks; and combining the results of the subtasks to obtain the task result.

One embodiment may be a computer program tangibly stored on a computer-readable medium and operable to cause a computer to enable distributed computing of a task. The computer program may comprise instructions to send a request to process the task from a server to a task processing module; decompose the task into a plurality of subtasks; distribute the subtasks to processors; determine if code exists at the processors to process the subtasks; obtain the code from a code source when the code does not exist at the processors; determine if data exists at the processors for the subtasks; obtain the data from a data source when the data does not exist at the processors; execute the code to obtain results for the subtasks; and combine the results of the subtasks to obtain a task result.

Aspects of the embodiments may comprise using dynamically linked libraries to request a task, decompose the task into subtasks, distribute the subtasks, execute the subtasks and obtain the results. Another aspect may include maintaining updated lists of modules that may be available to process the subtasks and lists of approved modules from which subtasks may be distributed. Module availability may be updated by modules providing availability signals at predetermined intervals, such that modules providing a signal may be added to the list and modules not providing a signal may be removed from the list. An aspect of the system and method embodiments may comprise monitoring of the subtask processing, with the subtasks being redistributed among modules when processing at one of the modules may be delayed. The monitoring may be through a browser application, such that monitoring and other system functions may be operable from remote sites.

### BRIEF DESCRIPTION OF THE DRAWINGS

The following figures depict certain illustrative embodiments in which like reference numerals refer to like elements. These depicted embodiments are to be understood as illustrative and not as limiting in any way.

FIG. 1 is a block diagram illustrating components of a distributed processing system; and

FIG. 2 is a flow chart showing a method for distributing the processing of tasks among a number of processors.

### DETAILED DESCRIPTION OF CERTAIN ILLUSTRATED EMBODIMENTS

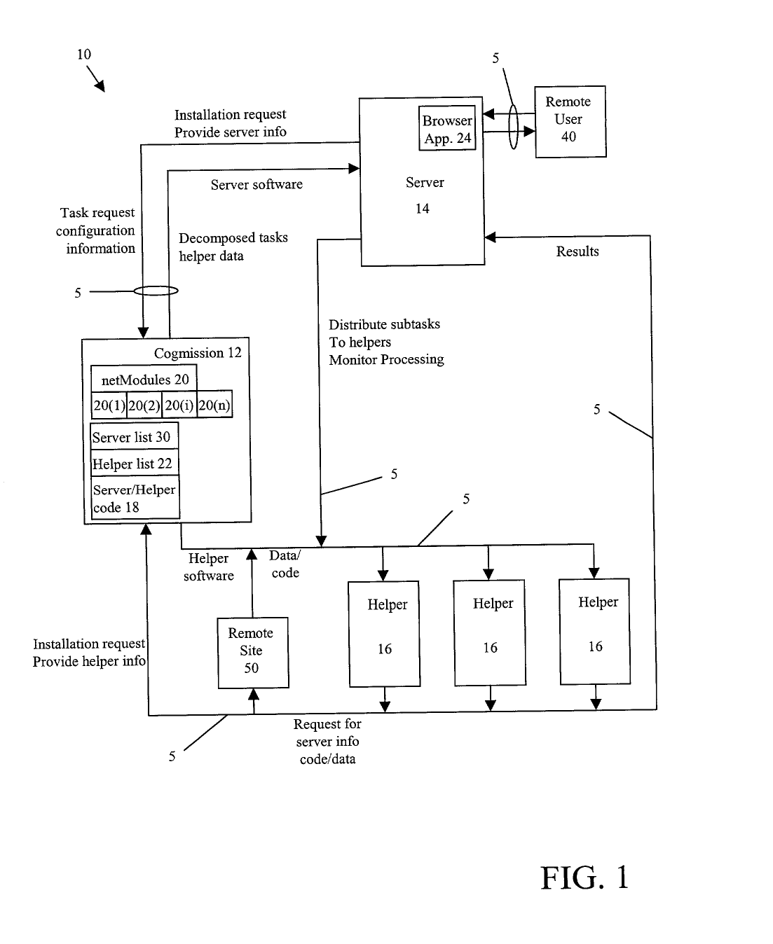

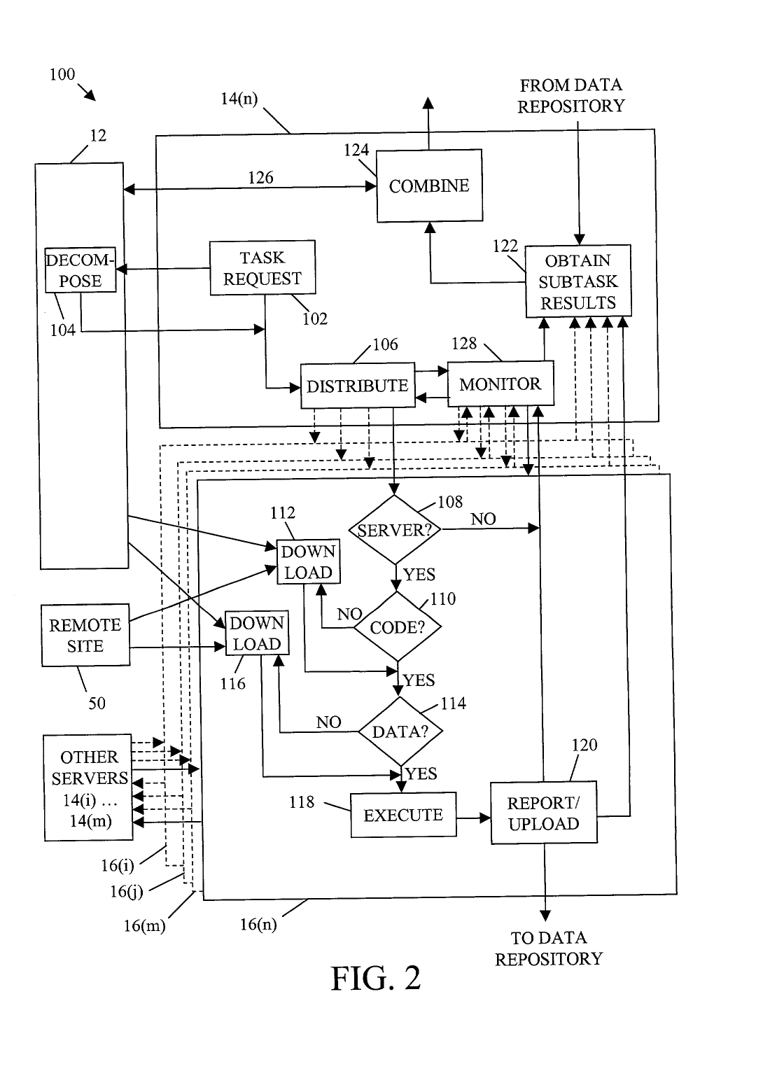

Referring now to FIGS. 1 and 2, there are illustrated a block diagram of a distributed computing system 10 and a schematic flow chart of a distributed computing method 100, respectively. System 10 may be adapted to numerous processing tasks, with particular application to tasks that can benefit from parallel execution of task subparts. Generally, system 10 may include three main components implemented on computers or processing stations, which may be connected through a network (shown as lines and arrows 5 in FIG. 1), such as the internet, an intranet, a local area network, or a wide area network. Cogrnission module 12 can provide the overall administration for system 10, which may include maintaining updated versions of system parameters and software. In implementing method 100, server module 14 can initiate a task request at 102, which can be decomposed at 104 into subtasks. The subtasks can be apportioned at 106 to helper modules 16, which in turn, can process the subtasks.

The illustrated server 14, cogmission module 12, and helpers 16 can include one or more microprocessor-based systems including a computer workstation, such as a PC workstation or a SUN workstation, handheld, palmtop, laptop, personal digital assistant (PDA), cellular phone, etc., that includes a program for organizing and controlling the microprocessor to operate as described herein. Additionally and optionally, the microprocessor device(s) 12, 14, 16 can be equipped with a sound and video card for processing multimedia data. The device(s) 12, 14, 16 can operate as a stand-alone system or as part of a networked computer system. Alternatively, the device(s) 12, 14, 16 can be dedicated devices, such as embedded systems, that can be incorporated into existing hardware devices, such as telephone systems, PBX systems, sound cards, etc. In some embodiments, device(s) 12, 14, 16 can be clustered together to handle more traffic, and can include separate device(s) 12, 14, 16 for different purposes. The device(s) 12, 14, 16 can also include one or more mass storage devices such as a disk farm or a redundant array of independent disk (“RAID”) system for additional storage and data integrity. Read-only devices, such as compact disk drives and digital versatile disk drives, can also be connected to the server 14.

Those with ordinary skill in the art will also recognize that the elements of FIGS. 1 and 2 can be combined or otherwise rearranged, and that the illustration of components and modules is merely for illustrative purposes. For example, the cogmission module 12 may be combined with server 14. In some embodiments, cogmission module 12 and server 14 can thus be understood to represent a client-server model. Other modules, including the helpers 16, can also be understood in some embodiments to represent part of a client-server model.

In a first instance, a user (not shown) desiring to make use of system 10 may access Cogmission module 12 to become a server module 14 or a helper module 16. The server or helper computer instructions or software code (shown as 18 in FIG. 1) may be uploaded from Cogmission module 12, or otherwise delivered to the user for installation on the user's processing platform. It will be noted that access to Cogmission module 12 and delivery to the user may take a number of forms, such as electronic access and downloads over network connections 5, or purchases from a systems distributor. During the installation and registration procedures, the user can provide administrative information to Cogmission module 12, such as user addresses, operating systems, processing requirements, etc.

In initiating a task request at 102, server 14 can direct a task request to an appropriate netModule 20(n), which may otherwise be known as a task processing module. The task request may be in the form of a dynamically linked library (dll), which may define the request by providing the links to the netModules 20 that can be used to obtain results for the task, links to data to be processed by the task and links to files for storing the results. The use and preparation of dll's are known and provide efficient means for sharing files between tasks. The netModules 20 may be specific to the problem or task requested and the model used to solve the problem, e.g., a weather data processing task may be directed to a netModule 20(1) having a long range forecasting model, or to a netModule 20(2) having a short range forecasting model, or to a netModule 20(i) having a hurricane model. By using dll linking, netModules 20 may be located at any site accessible by dll linking, e.g., at Cogmission module 12, server 14, or remote site 40.

In one embodiment, however, Cogmission module 12 may serve as a clearinghouse for netModules 20 in that it may maintain updated copies or links to updated copies of the netModules 20. Updates may be provided to Cogmission module 12 from servers, helpers, or other system users that may have an interest in distributed computing. FIGS. 1 and 2 may illustrate this configuration as FIG. 1 shows netModules 20 within Cogmission module 12 and FIG. 2 shows the task request at 102 being directed to Cogmission module 12.

The task request from server 14 can include configuration information required for the chosen netModule 20(n), such as execution parameters defining the processing limits (accuracy, number of iterations for the subtasks, etc.) or the boundaries of the data set. The configuration information may also include such information as the number of processors, or helpers 16, desired and the destination files for results. Server 14 may maintain configuration sets for the netModules 20 that it may use such that the configuration information need not be regenerated each time a task is initiated.

The chosen netModule 20(n) can decompose the task at 104 into a number of subtasks and provide the subtasks to server 14. The subtasks may be provided in a compressed format so as to minimize transmission requirements. Compression algorithms known to those skilled in the art may be used. Server 14 distributes the subtasks at 106 to helpers 16, with a helper 16(n) receiving one subtask from server 14.

In distributing the subtasks, server 14 may maintain a list 22 of helpers 16 that may be available to process the subtask. The helper list 22 may be part of the configuration information provided by server 14, such that netModule 20(n) can assign the subtasks to helpers 16 from the list 22. Alternatively, and as shown in FIG. 1, Cogmission module 12 may maintain helper list 22 and so avoid list duplication. The helper list 22 may be updated upon the receipt of availability signals from active helpers 16. Helpers 16 may be configured so as to periodically send a signal to indicate their availability to process a subtask. Helpers 16 providing the availability signal can be added to helper list 22, and helpers 16 not providing the signal may be removed from helper list 22.

Upon receiving a subtask, or a request to process a subtask, helper 16(n) may first check at 108 to determine if server 14 is on an approved server list 30. Server list 30 may be maintained on Cogmission 12 or on an associated server data site (not shown). Alternatively, helper 16(n) may maintain its own internal list of approved servers (not shown) based on server information from server list 30. This internal list may be updated at predetermined intervals in a manner consistent with updating helper list 22. The server information maintained within server list 30 may be information provided by server 14 when server 14 registers with, or installs, system 10. Such information can include information useful to helper 16(n) in determining the suitability of server 14, such as the type of organization server 14 represents, e.g., non-profit, university laboratory, governmental, etc. and the purpose for which the distributed computing of system 10 is being used, e.g., determination of cancer causing genes, weather forecasting, weapons research, etc.

In one embodiment, helper 16(n) may be dedicated to a server 14. For example, in a laboratory setting having multiple computers, one such computer may be designated as the laboratory server, with the remaining computers designated as helpers. The approved server list for the helpers in this setting may include solely the designated laboratory server. It can be seen from the above description that server list 30 for helper 16(n), whether maintained at Cogmission module 12, as indicated in FIG. 1, maintained at an associated server data site, or as updated at helper 16(n), may be used to determine the servers 14 that may receive the availability signal from helper 16(n).

If helper 16(n) accepts the subtask from server 14, helper 16(n) may then verify at 110 if it has the code, i.e., the computer instructions, necessary to process the subtask, either located on helper 16(n) or provided with the subtask. In performing the verification, helper 16(n) may further determine if the code must be updated. If an update is required or the code is not available, helper 16(n) may obtain the necessary or updated code at download 112 from netModule 20(n), or from other sources, such as remote site 50, as provided in the subtask request from server 14. The code may be a dynamically linked library (dll) and may include functions that might be encoded in a dll. In using dll code, the system 10 provides flexibility in preparing netModules 20, as choices among languages that generate dll's, such as C, Pascal, Fortran, Java, etc., may be available.

In a manner similar to verifying the code at 110, helper 16(n) may check at 114 if data to be processed may need to be downloaded at 116 from sources as provided in the subtask request from server 14, including local databases, server 14 databases, or remote databases that may be accessed by helper 16(n). Once the code and data are obtained, helper 16(n) can execute the subtask at 120.

It can be seen from the above description that helper 16(n) may provide processing for a number of servers 14. In a first instance, helper 16(n) may determine if it wishes to process a subtask for the requesting server 14(n), which may be one from a listing of approved servers. Secondly, helper 16(n) can process various types of subtasks by accessing the code necessary to process a received subtask. Thus, helper 16(n) may run an air dispersion model subtask at one point, a Monte Carlo simulation subtask at another and a computer graphics rendering at still another point. In this same regard, servers 14 may initiate multiple tasks, providing server 14 includes sufficient processing power to execute the dll's for the tasks. Referring more specifically to FIG. 2, server 14(n) may distribute at 106 the subtasks to helpers 16, shown in FIG. 2 as 16(i), 160(j) . . . 16(m) and 16(n). Additionally, helpers 16 can be seen to receive tasks from a number of servers 14, shown in FIG. 2 as servers 14(i) through 14(m).

When helper 16(n) completes a subtask, it may report to server 14 at 122 that the subtask is completed. Results may be uploaded to server 14, or to some other data repository to which helper 16(n) can connect (also shown at 122). As with transmission of the subtasks, the results of the subtasks may be compressed to minimize transmission requirements. Upon completion of the subtasks at the helpers 16 to which the subtasks were distributed, the server 14 may obtain the results at 122 and may then combine the results at 124 to produce the desired results. In one embodiment, the combined results are directed to the appropriate netModule 20 to obtain the desired results, as indicated by arrow 126.

During processing of the subtasks, server 14 may monitor progress among helpers 16 at 128, and may reschedule tasks to different helpers 16 if subtasks appear delayed (as indicated by flow from 128 to 106 in FIG. 2). Additionally, it may be necessary to monitor progress from a site other than server 14, e.g., remote site 40. Using network connection 5, remote site 40 can access a browser application 24 at server 14 that can provide the progress monitoring data to remote site 40. Browser application 24 at server 14 can be part of the server computer instructions or software code uploaded or delivered from Cogmission module 12 and may include such known browser applications as Netscape Navigator, Internet Explorer, or other similar applications. Depending on a predetermined access level for remote site 40, browser application 24 can be used by remote site 40 to reschedule subtasks among helpers 16, or to initiate tasks through server 14.

Though not shown in FIG. 1, it can be readily understood that Cogmission module 12 also may include browser application 24. Thus remote site 40 can initiate tasks directly through Cogmission module 12, which may function as server 14 to remote site 40, without the need to upload the server instructions or software to remote site 40. However, the use of the browser application 24 interface in lieu of installing the server computer instructions or software code may decrease overall task completion speed.

While the method and systems have been disclosed in connection with the illustrated embodiments, various modifications and improvements thereon will become readily apparent to those skilled in the art. In one embodiment, decomposition 104 may consist of providing dll code directing the helpers 16 to separate their subtask from the requested task. As previously noted, netModules 20 need not be located in Cogmission module 12. In such applications, server 14 may not need further access to Cogmission module 12 once the appropriate computer instructions or software code 18 have been installed.

In another embodiment, the dll for the task request may be iterative, i.e., a task request may be repeatedly initiated until predetermined criteria are met. The task results from one iteration, i.e., the combined results of the subtasks, may be used as data for the next iteration, etc. In such cases the configuration information can include the criteria for determining the number of iterations, such as a specified number of iterations of the task, or an acceptable level of change in the task results between iterations. Accordingly, the spirit and scope of the present methods and systems is to be limited only by the following claims.

What is claimed is:

1. A method for distributed computing, comprising:
sending from a server to a task processing module, a request to process a task;
receiving the task at the task processing module;
decomposing the task into a plurality of subtasks;
returning the subtasks to the server;
distributing the subtasks from the server to processors;
receiving the subtasks at the processors;
determining at the processors if code resides at the processors to process the subtasks received;
obtaining at the processors the code from a code source when the code does not exist at the processors;
determining at the processors if data exists at the processors for the subtasks received;
obtaining at the processors the data from a data source when the data does not exist at the processors;
executing at the processors the code to obtain results for the subtasks;
notifying the server that the results for the subtasks are obtained;
combining the results of the subtasks to obtain a task result.

2. The method of claim 1, comprising maintaining updated versions of at least one of system parameters, processing code and system operation code at the task processing module.

3. The method of claim 2, wherein maintaining comprises updating system parameters taken from a list including server addresses, server operating system identification, server organizational type, server task purpose, processor operating system identification and server processing requirements.

4. The method of claim 3, wherein receiving the subtasks at the processors comprises checking system parameters to determine if the server is an approved server.

5. The method of claim 1, wherein sending the request to process a task comprises forming a dynamically linked library having links to at least one of processing code, code sources, data, data sources and results storage files.

6. The method of claim 5, comprising:
defining configuration sets for tasks to be requested by the server; and
incorporating in the dynamically linked library one of the configuration sets corresponding to the task in the request to process a task.

7. The method of claim 6, wherein defining the configuration sets comprises identifying at least one of subtask processing limits, boundary limits for the data, iteration limits and a number of processors desired for processing.

8. The method of claim 7, wherein combining comprises iteratively sending requests to process the task results based on the iteration limits.

9. The method of claim 6, wherein defining the configuration sets comprises maintaining a list of processors available to execute the code to obtain the results for the subtasks.

10. The method of claim 9, wherein maintaining the list comprises adding to the list processors for which availability signals are received and removing from the list processors for which availability signals are not been received within a predetermined period.

11. The method of claim 1, wherein returning the subtasks comprises compressing files corresponding to the subtasks.

12. The method of claim 11, wherein executing comprises compressing files corresponding to the results for the subtasks.

13. The method of claim 1, wherein executing comprises compressing files corresponding to the results for the subtasks.

14. The method of claim 1, comprising maintaining a list of processors available to execute the code to obtain the results for the subtasks.

15. The method of claim 14, wherein maintaining the list comprises adding to the list processors for which availability signals are received and removing from the list processors for which availability signals are not been received within a predetermined period.

16. The method of claim 1, wherein distributing comprises:
monitoring the processors; and
redistributing the subtasks when executing at the processors is delayed.

17. The method of claim 16, wherein monitoring comprises:
accessing the server from a remote site; and
initiating a browser application within the server, the browser application providing remote monitoring functionality.

18. The method of claim 1, wherein combining comprises iteratively sending requests to process the task results.

19. A distributed computing system, comprising:
a server module adapted to request processing of a task;
a processing module adapted to receive the task, decompose the task into a plurality of subtasks and return the subtasks to the server;
helper modules adapted to receive the subtasks distributed by the server, to obtain processing code and data to process the subtasks and return subtask results to the server, wherein the subtask results are combined to obtain a task result.

20. The system of claim 19, wherein the server module, the processing module and the helper modules are connected via a network.

21. The system of claim 20, wherein the network is one of an internet, an intranet, a local area network and a wide area network.

22. The system of claim 19, wherein the processing module is adapted to maintain at least one of updated system parameters, processing code and system operation code.

23. The system of claim 22, wherein the updated system parameters comprise at least one of server module addresses, server module operating system identification, server module organizational type, server module task purpose, helper module operating system identification and server module processing requirements.

24. The method of claim 23, wherein the helper modules verify the system parameters for the server module to determine if the server module is an approved server module.

25. The system of claim 19, comprising a dynamically linked library formed by the server module and adapted to provide links to at least one of processing code, data and subtask results storage files.

26. The system of claim 25, wherein the dynamically linked library comprises configuration information for the processing module and helper modules.

27. The system of claim 26, wherein the configuration information comprises at least one of subtask processing limits, boundary limits for the data, iteration limits and a number of helpers desired for processing.

28. The system of claim 27, comprising an iterative module adapted to iteratively request processing the task results based on the iteration limits.

29. The system of claim 26, wherein the configuration information comprises a helper module list of helper modules for which an availability signal has been received.

30. The system of claim 19, wherein the processing module comprises a subtask compression module adapted to return the subtasks in a compressed format.

31. The system of claim 30, wherein the helper modules comprise a results compression module adapted to return the subtask results in a compressed format.

32. The system of claim 19, wherein the helper modules comprise a results compression module adapted to return the subtask results in a compressed format.

33. The system of claim 19, comprising a helper module list of helper modules available to receive, process and return results for the subtasks.

34. The system of claim 33, wherein the helper modules initiate periodic availability signals to update the helper module list, whereby helper modules for which availability signals are received are added to the helper module list and helper modules for which availability signals are not received are removed from the helper module list.

35. The system of claim 19, wherein the server module comprises a monitoring module adapted to monitor the helper modules and redistribute the subtasks when at least one of the helper modules is delayed.

36. The method of claim 35, wherein the monitoring module comprises a browser application for accessing the server from a remote site and monitoring the helper modules from the remote site through the browser application.

37. The method of claim 19, comprising a browser application adapted to access the server from a remote site and operate the system from the remote site.

38. The method of claim 19, comprising an iterative module adapted to iteratively request processing the task results.

39. A method for distributed computing, comprising:
decomposing a task into a plurality of subtasks;
distributing the subtasks to processors;
determining at the processors if processing code exists at the processors to process the subtasks received;
obtaining at the processors the processing code from a code source when the code does not exist at the processors;
executing at the processors the processing code to obtain results for the subtasks;
combining the results of the subtasks to obtain a task result.

40. The method of claim 39, comprising maintaining updates of the processing code at the code source.

41. The method of claim 39, comprising forming a dynamically linked library to provide links to at least one of processing code, code sources and storage files for results of the subtasks.

42. The method of claim 39, wherein decomposing comprises compressing files corresponding to the subtasks.

43. The method of claim 42, wherein executing comprises compressing files corresponding to the results for the subtasks.

44. The method of claim 39, wherein executing comprises compressing files corresponding to the results for the subtasks.

45. A method for distributed computing, comprising:
decomposing a task into a plurality of subtasks;
distributing the subtasks to processors;
determining at the processors if data exists at the processors for the subtasks received;
obtaining at the processors the data from a data source when the data does not exist at the processors;
executing at the processors the subtasks using the data to obtain results for the subtasks;
combining the results of the subtasks to obtain the task result.

46. The method of claim 45, comprising forming a dynamically linked library to provide links to at least one of data, data sources and storage files for results of the subtasks.

47. The method of claim 45, wherein decomposing comprises compressing files corresponding to the subtasks.

48. The method of claims 47, wherein executing comprises compressing files corresponding to the results for the subtasks.

49. The method of claims 45, wherein executing comprises compressing files corresponding to the results for the subtasks.

50. A computer program tangibly stored on a computer-readable medium and operable to cause a computer to enable distributed computing of a task, the computer program comprising instructions to:
send a request to process the task from a server to a task processing module;
decompose the task into a plurality of subtasks;
distribute the subtasks to processors;
determine if code exists at the processors to process the subtasks;
obtain the code from a code source when the code does not exist at the processors;
determine if data exists at the processors for the subtasks;
obtain the data from a data source when the data does not exist at the processors;
execute the code to obtain results for the subtasks; and
combine the results of the subtasks to obtain a task result.

51. The computer program of claim 50, comprising instructions to maintain updated versions of at least one of system parameters, processing code and system operation code at the task processing module.

52. The computer program of claim 51, wherein the instructions to maintain comprise instructions to update system parameters taken from a list including server addresses, server operating system identification, server organizational type, server task purpose, processor operating system identification and server processing requirements.

53. The computer program of claim 52, comprising instructions to check system parameters to determine if the server is an approved server.

54. The computer program of claim 50, wherein the instructions to send the request to process a task comprise instructions to form a dynamically linked library having links to at least one of processing code, code sources, data, data sources and results storage files.

55. The computer program of claim 54, comprising instructions to:
define configuration sets for tasks to be requested by the server; and
incorporate in the dynamically linked library one of the configuration sets corresponding to the task in the request to process a task.

56. The computer program of claim 55, wherein the instructions to define the configuration sets comprise instructions to identify at least one of subtask processing limits, boundary limits for the data, iteration limits and a number of processors desired for processing.

57. The computer program of claim 56, wherein the instructions to combine comprise instructions to iteratively send requests to process the task results based on the iteration limits.

58. The computer program of claim 55, wherein the instructions to define the configuration sets comprise instructions to maintain a list of processors available to execute the code to obtain the results for the subtasks.

59. The computer program of claim 58, wherein the instructions to maintain the list comprise instructions to add to the list processors for which availability signals are received and instructions to remove from the list processors for which availability signals are not been received within a predetermined period.

60. The computer program of claim 50, wherein the instructions to decompose comprise instructions to compress files corresponding to the subtasks.

61. The computer program of claim 60, wherein the instructions to execute comprise instructions to compress files corresponding to the results for the subtasks.

62. The computer program of claim 50, wherein the instructions to execute comprise instructions to compress files corresponding to the results for the subtasks.

63. The computer program of claim 50, comprising instructions to maintain a list of processors available to execute the code to obtain the results for the subtasks.

64. The computer program of claim 63, wherein the instructions to maintain the list comprise instructions to:
add to the list processors for which availability signals are received; and
remove from the list processors for which availability signals are not been received within a predetermined period.

65. The computer program of claim 50, wherein the instructions to distribute comprise instructions to:
monitor the processors; and
redistribute the subtasks when results of one of the subtasks is delayed.

66. The computer program of claim 65, wherein the instructions to monitor comprise instructions to:
access the server from a remote site; and
initiate a browser application within the server, the browser application providing remote monitoring functionality.

67. The computer program of claim 50, wherein the instructions to combine comprise instructions to iteratively send requests to process the task results.
